(19) United States
(12) Patent Application Publication
(10) Pub. No.: US 2008/0135064 A1
(43) Pub. Date: Jun. 12, 2008

(54) Mobile System For Treating of Objects, Collecting Pad and Method of Treating Objects

(75) Inventor: Karsten Knudsen, Hejnsvig (DK)

Correspondence Address: CANTOR COLBURN, LLP, 20 Church Street, 22nd Floor, Hartford, CT, 06103, US

(73) Assignee: CLENUX A/S, Kolding (DK)

(21) Appl. No.: 10/593,161

(22) PCT Filed: Mar. 17, 2005
(86) PCT No.: PCT/DK2005/000182

§ 371 Date: Sep. 26, 2007

(30) Foreign Application Priority Data
Mar. 17, 2004 (DK) PA 2004 00434
Dec. 2, 2004 (DK) PA 2004 01885

(51) Int. Cl. B08B 17/00; B08B 3/00

(52) U.S. Cl. 134/10; 134/104.2; 134/123; 134/174

(57) ABSTRACT

Mobile unit for treating, cleaning, washing etc. of objects such as vehicles, aircrafts, machines, containers etc. The mobile unit comprises—transport means, —a flexible collecting pad (2) with barrier means including inflatable barrier means (4), —means (98) for supplying air for inflating said inflatable barrier means (4), —transferring means (14, 30) for fluids collected on said collecting pad 2, —a storage tank (78) for collected fluids, —a storage tank (76) for fluid, e.g. water, for washing said object, —means (90, 92) for delivering and applying said fluid, e.g. said water, wherein said flexible collecting pad (2) is stored on a separate handling device (60) that is movable in relation to said transport means.

### FIELD OF THE INVENTION

The invention relates to a mobile system for treating, cleaning, washing etc. of objects such as vehicles, aircrafts, machines, containers etc. Further, the invention relates to a handling device for storage and handling of a flexible collecting pad, said collecting pad being designed for collecting of a fluid such as water.

The invention also relates to a collecting pad for treating, cleaning, washing etc. of objects. Finally, the invention relates to a method of treating, cleaning, washing etc. of objects such as vehicles, aircrafts, machines, containers etc.

### BACKGROUND OF THE INVENTION

Aircrafts are usually washed with regular intervals, not only for aesthetical reasons but also in order to achieve an optimal efficiency. It has been acknowledged that dirt, for example combustion residues, soot, etc. from the engines tend to collect on the aircraft body, the wings etc. and will influence the aerodynamics of the aircraft negatively. This will have the effect that larger amounts of fuel are needed. Further, brake dust etc. may also collect on aircraft parts, which may also have a negative effect on the aerodynamics, but further, brake dust etc. may comprise harmful materials that may not be allowed to escape. Thus, when the aircraft is washed, special measures must be used in order to make sure that oil, fuel, brake dust, cleaning agents, soap, de-icing residues and other potentially harmful matters are not transferred to e.g. the nature and/or the normal sewage system, but are collected and treated in a environmentally correct manner. In order to ensure this, the used wash water must not be led to the normal sewage system, but must be collected and treated in a predetermined manner. Therefore, special wash locations are located at airports. However, uses of such wash places are connected with a number of disadvantages, including a limited capacity. Further, it will be necessary to transport the aircrafts to such wash places, which means that e.g. an aircraft mechanic must be present when a plane is transported to the wash place, thus adding to the costs involved. Therefore, it is desirable that washing of airplanes etc. may take place at e.g. airport ramps, in hangars, or other places, where it is found convenient.

Further, the need to collect used wash water from the cleaning of other objects such as vehicles, trucks, etc. has also been acknowledged in order to be able to treat the contaminated wash water in an environmentally correct manner.

Special cleaning facilities for aircrafts in airports are as mentioned already known, e.g. stationary washing locations where special measures are provided for collecting the used wash water. Similar prior art techniques are also described in the patent literature.

An example of this is WO 95/31368 A1, wherein a system for collecting and reusing de-icing fluids used in connection with aircrafts is disclosed. This system comprises a special mat as a part of a static structure that may be located at an airport ramp. This structure also comprises equipment for spraying of de-icing fluid, vacuum pumps for collecting of the fluid, etc. The mat has a size corresponding to the size of the aircraft and is equipped with a plurality of channels for collecting and directing the fluid to the outer edges of the mat. Further, the mat is equipped with heating elements that prevents the de-icing fluid from freezing on the mat. Evidently, this prior art system is relative complicated and spacious, and according to this prior art the aircrafts also have to be transported to and onto the mat.

Further, U.S. Pat. No. 5,597,001 discloses a portable wash station for vehicles. This station, however, is also rather extensive and complicated. The vehicle is driven into a pond that has a flooring system with three layers and a containment wall for keeping the used wash water inside the pond. The vehicle is driven over the containment wall on a special track strip. It is evident that such a system is not suitable for washing of aircrafts and further, when used for vehicles, it is evident that it will be time-consuming to erect, disassemble and move such a system, even though it is portable.

Further, U.S. Pat. No. 5,423,339 discloses an apparatus for treating articles such as vehicles with a spray washer where used wash water is collected with a wash pad and transferred to a receptacle or to a water treatment unit. The wash pad has a fluid impermeable bottom sheet and a primary and a secondary wall connected to the bottom sheet. These walls may be formed from an inflatable tube, but certain parts may be formed with sponge or other durable material. The primary wall defines a first containment area on the bottom sheet and the second wall is connected to the primary wall in order to define a second containment area on the bottom sheet. The first containment area is large enough to accommodate a vehicle that has to be washed, i.e. the vehicle is driven over the secondary wall, across the second containment area and over the primary wall into the first containment area. Here, the vehicle is parked and washed in a conventional manner. The used wash water, which may contain soap, dirt, oil, etc. is collected in the first containment area and pumped by means of a submersible pump placed in this area to a receptacle. When the vehicle has been washed, it is driven from the first containment area and across the second containment area. In this manner, the used wash water that is present in the first containment area when the vehicle crosses the first containment wall, may escape to the second containment area, when the wheels of the vehicle flatten the containment wall surrounding the first area.

However, it will be understood that the used wash water that may flow into the second containment area when the wheels cross the wall between the two areas, may escape onto the ground when the vehicle is driven from the second area onto the surrounding area. Thus, this prior art technique does not prevent the contaminated and dirty water from entering the sewage system or seeping into the ground, but may only limit the problem to a certain extent.

Further, U.S. Pat. No. 5,423,339 discloses a wash truck which houses spray wash equipment including a high pressure pump etc. that is driven by power from the wash truck. Further, the truck comprises a water treatment unit or a receptacle for the wash water, which is transferred from the wash pad by means of a submersible pump, which is placed at an appropriate location on the pad. Still further, the truck comprises a reel for accommodating the wash pad in a rolled-up configuration. This reel is located at the rear of the truck, which also comprises a compressor for inflating the first and second inflatable walls. When deploying the wash pad, it is unrolled from the reel, while the truck is moving forward, whereby the pad is laid-out on the ground, Hereafter, the inflatable parts are inflated, the submersible pump, which is connected with flexible tubing to the storage tank on the truck, is placed on the pad, and a vehicle is driven onto the pad as described above, where after the washing may be performed.

It is noted that since a submersible pump is used according to this prior art, the water level in the wash pad will be relatively high, which emphasizes the need for means for preventing the water from escaping when a vehicle drives into or out from the first containment pad. However, as explained above, water spillage to the ground cannot be completely prevented according to this prior art.

Further, when using the dish wash truck according to this prior art, it is noted that the wash pad can only be placed at a location where the truck can drive, e.g. there has to be sufficiently free height for the truck to pass when the wash pad is unrolled, unless the wash pad is dragged manually along the ground which may prove to be a difficult task that further may increase the risk of puncturing the pad and increasing the wear on the pad.

U.S. Pat. No. 5,560,782 and U.S. Pat. No. 5,666,982 disclose prior art systems and devices corresponding to those disclosed in U.S. Pat. No. 5,423,339.

It is an objective of the invention to provide an improved mobile unit for treating, cleaning, washing etc. of objects.

It is also an objective of the invention to provide such a mobile unit that is versatile and may be used for a wide variety of objects such as vehicles, aircrafts, machines, containers etc.

It is further an objective of the invention to provide a handling device for storage and handling of a flexible collecting pad that alleviates the abovementioned drawbacks.

Further, it is an objective of the invention to provide such a handling device that may facilitate deployment of a collecting pad in a wide variety of utilizations such as for example in connection with vehicles, aircrafts, machines, containers etc.

It is a still further objective of the invention to provide an improved collecting pad for used wash water etc.

It is also an objective of the invention to provide such a collecting pad that ensures easy handling and prevents spillage of used wash water to the ground or to the sewage system.

In particular it is an objective of the invention to provide a collection pad that allows cleaning, washing etc. of for example an aircraft to be performed without having to move the aircraft to a special washing site.

These and other objectives are achieved by the invention as explained in the following.

### SUMMARY OF THE INVENTION

The invention relates to a mobile unit for treating, cleaning, washing etc. of objects such as vehicles, aircrafts, machines, containers etc., said mobile unit comprising
transport means,
a flexible collecting pad with barrier means including inflatable barrier means,
means for supplying air for inflating said inflatable barrier means,
transferring means for fluids collected on said collecting pad,
a storage tank for collected fluids,
a storage tank for fluid, e.g. water, for washing said object,
means for delivering and applying said fluid, e.g. said water,
   wherein said flexible collecting pad is stored on a separate handling device that is movable in relation to said transport means.

Hereby a number of advantages are achieved. First and foremost it is achieved that a wide variety of objects located in different locations may be cleaned, washed etc. using such a mobile unit, while the used wash water may easily be collected and then taken care of, for example stored in a tank on the transport means for later treatment or treated for immediate reuse. Further, since the collecting pad is stored on a separate handling device, it is achieved that a collecting pad may easily be unrolled and deployed at virtually any desired location, irrespective of whether it is possible for e.g. a vehicle to drive to such a location. The handling device may easily be unloaded from the vehicle that is normally used to transport it, and since the handling device is a separate unit, it may be e.g. pushed along the ground to the position where it is desired to locate one end of the collecting pad. Hereafter, the collecting pad may be unrolled from the rotatable element by means of the driving means, while the handling device may be e.g. pushed in the appropriate direction, until the collection pad has been completely unrolled. Following this, the collecting pad may readily be made ready for use, e.g. by inflating the barriers, connecting tubes for the vacuum pumping means etc.

Since the handling device is a separate unit, it is relatively small in size and relatively easy to move. Therefore, it may be pushed into restricted spaces, for example under aircrafts, under vehicles etc. thus allowing collecting pads to be unrolled directly at a desired location, e.g. under an aircraft or the like.

According to a preferable embodiment as characterized in claim 2, said transport means may comprise a trailer.

Hereby, it is achieved that such a mobile unit that comprises all necessary means for facilitating cleaning, washing etc. of vehicles, aircrafts, etc. may be designed as a compact and easily handled unit that further may easily be transported from place to place. In particular it is achieved that such a mobile unit based on a trailer may readily be placed in a container, e.g. a 20′ container, and be transported e.g. by ship or aircraft to a place where it is needed.

Advantageously, as specified in claim 3, said mobile unit may comprise an electric generator. Hereby, it is achieved that the mobile unit will be a fully self-contained unit, since all necessary power for driving the compressor, the handling unit, the pumps(s) etc. will be delivered by the unit itself.

Thus, the mobile unit may be deployed and used irrespective of, whether an electric power supply is available or whether a supply of water for cleaning is readily available at the location, where the object that has to be cleaned is located.

According to a further advantageous embodiment as specified in claim 4, said mobile unit may comprise means for reusing said collected fluid, e.g. said used wash water, said reusing means comprising filtering means.

Hereby further advantages are achieved. First and foremost the consumption of fresh water is greatly reduced, thus enhancing the environmental-friendliness of the solution according to the invention. Further, the mobile unit will to a higher degree be independent of a water supply, and/or the water storage tank capacity may be reduced, thus also reducing the size and the weight of the mobile unit.

According to a particular advantageous embodiment as characterized in claim 5, said mobile unit may comprise means for facilitating loading and unloading of said handling device.

Hereby, it is achieved that the handling unit may easily and effortlessly be loaded and unloaded. Such means may for example be hoisting means, hydraulically, pneumatically or electrically driven means etc., e.g. for example a hoist mounted on the carrier of the trailer, by means of which hoist the handling unit may be lowered onto the ground. For example, the carrier of the trailer may be tiltable, whereby the handling unit may be allowed to move downwards, controlled by the hoist, and similarly, it may easily be pulled onto the trailer again by means of the hoist. Other such means for loading and unloading of the handling unit may be used as well, such as for example a lift, a crane or cranes etc. for lifting/lowering the unit.

Preferably, as specified in claim 6, said transferring means for fluids collected on said collecting pad may comprise a vacuum pump.

Hereby, it is achieved that essentially all collected fluid, e.g. wash water, on the pad may be transferred to the storage thank or the water treatment facility, since a vacuum pump will not, to the same extent as is the case with a submersible pump, depend on a certain water level in order to be able to transfer the water from the collecting pad. Thus, an improved efficiency is achieved since the water level on the pad will normally be relatively low, thereby also reducing the risk that used wash water will escape from the collecting pad and to the ground or into the sewage system.

The invention also relates to a handling device for storage and handling of a flexible collecting pad, said collecting pad being designed for collecting of a fluid such as water, said handling device comprising
means for storage of said pad on a rotatable element such as a drum or a shaft,
a frame for carrying said means for storage of said pad, said frame having supporting wheels, and
means for driving said rotatable element in relation to the frame,
   wherein
said handling device is adapted for transport by a vehicle, e.g. a trailer, a truck etc., and
said handling device is separately movable.

Hereby, it is achieved that a collecting pad may easily be unrolled and deployed at virtually any desired location, irrespective of whether it is possible for e.g. a vehicle to drive to such a location. The handling device may easily be unloaded from the vehicle that is normally used to transport it, and since the handling device is a separate unit, it may be e.g. pushed along the ground to the position where it is desired to locate one end of the collecting pad. Hereafter, the collecting pad may be unrolled from the rotatable element by means of the driving means, while the handling device may be e.g. pushed in the appropriate direction, until the collection pad has been completely unrolled. Following this, the collecting pad may readily be made ready for use, e.g. by inflating the barriers, connecting tubes for the vacuum pumping means etc.

Since the handling device is a separate unit, it is relatively small in size and relatively easy to move. Therefore, it may be pushed into restricted spaces, for example under aircrafts, under vehicles etc. thus allowing collecting pads to be unrolled directly at a desired location, e.g. under an aircraft or the like.

Preferably, as specified in claim 8, said means for driving said rotatable element in relation to the frame may comprise an electric drive motor. Hereby it is achieved that the collecting pad may easily be unrolled.

According to a further advantageous embodiment as characterized in claim 9, said means for driving said rotatable element in relation to the frame may be designed for reversing the drive direction.

Hereby it is achieved that after use of the collecting pad it may readily be rolled up on the rotatable element on the handling device, e.g. one end of the collecting pad may be fastened to the rotatable element, the drive means may be started and the collecting pad will be rolled up, while the handling unit will be moved correspondingly. Due to this, the collecting pad will be rolled up in a tight and handy fashion.

According to another advantageous embodiment as characterized in claim 10, said handling device may comprise means for moving the handling device, such as drive means supported by the frame and connected to at least one of said supporting wheels. As mentioned above, said handling device may be moved, e.g. pushed manually, but instead it may be provided with e.g. an electric drive, fed with power via a cable from the transport vehicle or by means of a separate power source such as a rechargeable battery.

It is obvious that also the electric drive motor for unrolling or collecting the pad on the rotatable element may be driven by power delivered via a power cable from the transport vehicle or by a separate power source such as a rechargeable battery.

According to a particular advantageous embodiment as characterized in claim 11, said handling device may comprise means for facilitating unloading of the handling device from a vehicle, e.g. a trailer, a truck etc., and loading of the handling device onto the vehicle.

Hereby it is achieved that the handling unit may easily and effortlessly be loaded and unloaded. Such means may for example be hoisting means, hydraulically, pneumatically or electrically driven means etc.

The invention further relates to a collecting pad for treating, cleaning, washing etc. of objects such as vehicles, aircrafts, machines, containers etc., said pad being designed for collecting of a fluid such as water, e.g. wash water, said collecting pad comprising
a flexible base pad and
barrier parts extending essentially along the periphery of said flexible pad, said barrier parts being at least in part accommodated for folding and comprising inflatable parts,
   and wherein
   said inflatable parts that form part of said barrier parts are designed as longitudinally extending parts comprising at least two chambers extending along each other.

Hereby, it is achieved that it is further assured that used wash water will not enter the ground or a sewage system. In the prior art systems the inflatable wall surrounding the pads are in the form of a single chamber for air. During use and particularly after extended use, the risk that this chamber may be subjected to air leakages due to wear and tear etc. may be considerable, in which cases large amounts of dirty and contaminated water may escape. This risk is considerably reduced by the invention when at least two chambers located in parallel are present. If one of the chambers should develop a leakage, the other or the other chambers will maintain the barrier in its erected form and prevent the wash water from escaping.

Preferably, as specified in claim 13, said inflatable parts may comprise an essentially vertical wall member extending between said at least two chambers.

Hereby, a configuration having two chambers may be provided with relatively simple means.

According to a particular advantageous embodiment as characterized in claim 14, said flexible pad may comprise at least one incision, said at least one incision comprising incision barrier parts.

Hereby, it is achieved that the collecting pad may easily find use for objects that has support means etc. on the ground. Thus, the collecting pad may be deployed on the ground with said incision being arranged where said support is located. The pad may thus cover the ground beneath the object, whereby the used wash water may be collected, and the object need not be relocated, e.g. placed on the pad after the pad has been placed on the ground and deployed.

Advantageously, as specified in claim 15, at least part of said incision barrier parts may be designed as a covering extending at least in part in the vertical direction.

Hereby, it is achieved that for example a landing wheel on an aircraft or a support leg on a container may be covered, thus reducing the risk that wash water may escape onto the ground through said incision.

According to a further advantageous embodiment as characterized in claim 16, said at least one incision and said incision barrier parts may be configured to correspond essentially to support means for said object, e.g. landing wheels for an aircraft or wheels for a vehicle, a trailer, a machine etc. in such a manner that said incision barrier parts can be placed covering said support means.

Hereby, it is achieved that a collecting pad may easily, effectively and quickly be deployed, whereby the time necessary for washing e.g. an aircraft is greatly reduced, thereby also making the system according to the invention economically desirable.

Advantageously, as specified in claim 17, said at least one incision may comprise connecting means for connecting the two edges of the incision for at least part of the incision.

Hereby, the stability of the pad may be enhanced, e.g. even though an incision may be relatively long, the pad may still preserve its intended shape, and further, leakage of e.g. water to the ground may be reduced.

Preferably, as specified in claim 18, said connecting means for connecting the two edges of the incision may be designed to be essentially fluid-tight.

Hereby it is achieved that incisions in the part making up the bottom of the pad, which may be covered with water, may be provided.

According to a further advantageous embodiment as characterized in claim 19, said connecting means for connecting the two edges of the incision may comprise Velcro parts, zip-fastener parts or similar means.

Hereby, said fluid-tightness may be achieved in an expedient manner.

According to a still further advantageous embodiment as characterized in claim 20, said collecting pad for collecting of a fluid may comprise at least two of said flexible pads, each comprising barrier parts, wherein said flexible pads are designed for being assembled in a modular manner.

Hereby, it is achieved that a collecting pad may be built-up in a size and shape corresponding to a particular object, such as for example an aircraft, using for example standard collecting pads.

The invention also relates to a collecting pad for treating, cleaning, washing etc. of objects such as vehicles, aircrafts, machines, containers etc., said pad being designed for collecting of a fluid such as water, e.g. wash water, said collecting pad comprising
a flexible base pad and
barrier parts extending essentially along the periphery of said flexible pad, said barrier parts being at least in part accommodated for folding and comprising inflatable parts,
   and wherein
   said flexible base pad comprises at least two parts connected to each other to form said base part by means of complementary connecting means that are substantially fluid-tight and may be disconnected from each other.

Hereby, it is achieved that a collecting pad may be provided that may be include a part or parts that may be replaced, for example parts that are prone to wear, e.g. located at places, where the wheels of e.g. a vehicle will travel when such a vehicle is driven onto and off the pad. Further, such parts may be designed to be particularly resistant to wear, while other parts of the pad may be designed with parts not as durable to wear. Thus, a collecting pad may be provided that will be relatively light, and even though it may be provided with parts that are sufficiently sturdy to withstand long-time use, thus also making such a solution economically advantageous.

According to an advantageous embodiment as characterized in claim 22, said connecting means for connecting two edges of said at least two parts may comprise Velcro parts, zip-fastener parts or similar means.

Hereby, said parts may be connected to each other in a fluid-tight manner and said fluid-tightness may be achieved in an expedient manner.

The invention further relates to a collecting pad for treating, cleaning, washing etc. of objects such as vehicles, aircrafts, machines, containers etc., said pad being designed for collecting of a fluid such as water, e.g. wash water, said collecting pad comprising
a flexible base pad and
barrier parts extending essentially along the periphery of said flexible pad, said barrier parts being at least in part accommodated for folding and comprising inflatable parts,
   and wherein
   said flexible pad comprises at least one incision, said at least one incision comprising incision barrier parts.

Hereby, a collecting pad is provided that may easily find use for objects that has support means etc. on the ground. Thus, the collecting pad may be deployed on the ground with said incision being arranged where said support is located. The pad may thus cover the ground beneath the object, whereby the used wash water may be collected, and the object need not be relocated, e.g. placed on the pad after the pad has been placed on the ground and deployed.

Preferably, as specified in claim 24, at least part of said incision barrier parts may be designed as a covering extending at least in part in the vertical direction.

Hereby, it is achieved that for example a landing wheel on an aircraft or a support leg on a container may be covered, thus reducing the risk that wash water may escape onto the ground through said incision.

According to a further preferable embodiment, as specified in claim 25, said at least one incision and said incision barrier parts may be configured to correspond essentially to support means for said object, e.g. landing wheels for an aircraft or wheels for a vehicle, a trailer, a machine etc. in such a manner that said incision barrier parts can be placed covering said support means.

Hereby, it is achieved that a collecting pad may easily, effectively and quickly be deployed, whereby the time necessary for washing e.g. an aircraft is greatly reduced, thereby also making the system according to the invention economically desirable.

Advantageously, as characterized in claim 26, said at least one incision may comprise connecting means for connecting the two edges of the incision for at least part of the incision.

Hereby, the stability of the pad may be enhanced, e.g. even though an incision may be relatively long, the pad may still preserve its intended shape, and further, leakage of e.g. water to the ground may be reduced.

Further, as specified in claim 27, said connecting means for connecting the two edges of the incision may be designed to be essentially fluid-tight.

Hereby it is achieved that even incisions in the part making up the bottom of the pad, which may be covered with water, may be provided.

Preferably, as specified in claim 28, said connecting means for connecting the two edges of the incision may comprise Velcro parts, zip-fastener parts or similar means.

Hereby, said fluid-tightness may be achieved in an expedient manner.

Preferably, as specified in claim 29, said collecting pad may comprise inlet means for means such as a tube for transferring collected fluid away from the collecting pad.

Hereby, it is achieved that after the collecting pad has been unrolled and the barriers possibly erected, e.g. inflated, the tube or tubes for used wash water may easily be connected to the pad.

Advantageously, as specified in claim 30, said inlet means may comprise a connection pipe extending through the collecting pad, preferably through a barrier part.

Such a pipe or pipes may be provided as integrated parts of the pad, for example in the vicinity of the corners, thus making it easy to establish draining positions at the pad for transferring collected water by means of e.g. the vacuum pump.

According to a particular advantageous embodiment as characterized in claim 31, said inlet means may comprise a conduit placed at one or both ends of the collecting pad extending essentially along the barrier parts inside the collecting pad, said conduit comprising inlet holes facing downwards and a connecting part for fluid transferring means.

Hereby, inlet means for e.g. the vacuum pump for transferring collected water may be provided as an integrated part that allows the tube from the pump to be connected to the collecting pad quickly and easily. Further, such a conduit, e.g. a pipe or relatively inflexible tube, may serve as inlet means along a substantial width of the collecting pad, whereby collected water with certainty will be pumped away, even though the pad may be located at a slightly sloping ground. Still further, in spite of that the collecting pad is provided with such a relatively stiff conduit, e.g. a pipe or an inflexible tube, as an integrated part, the collecting pad may still be rolled up, since this conduit is placed at the end of the collecting pad, i.e. in parallel with the axis of the rolled-up pad.

Advantageously, as specified in claim 32, said flexible base pad and/or said barrier parts may be manufactured from a material that is fluid-tight and resistant to cleaning agents, oil, fuel etc.

Hereby, a durable and environmental-friendly collecting pad is provided.

Preferably, as specified in claim 33, said flexible base pad and/or said barrier parts may be manufactured from a material with a surface having efficient friction properties also when the surface is wet, e.g. with slip-resistant property.

Hereby, it is achieved that an enhanced safety and ease of use is achieved, since the user that may need to stand and move on the collecting pad when e.g. washing a vehicle, will be able to operate without worrying about a slippery condition. Thus, the work, e.g. the washing, may be performed faster and with greater care, and last but not least the safety of the user is enhanced.

According to a further advantageous embodiment as characterized in claim 34, said flexible base pad may be manufactured from a reinforced material, e.g. with web-reinforcing means.

Hereby, the durability and the resistance to wear have been enhanced, thus providing a pad with a relatively long effective operating time.

According to a particular advantageous embodiment as characterized in claim 35, said flexible base pad may be provided with at least a further reinforcing layer in specific areas, in particular tracks for wheels of e.g. vehicles.

Hereby, it is achieved that a collecting pad may be provided that are prone to wear, e.g. at places, where the wheels of e.g. a vehicle will travel when such a vehicle is driven onto and off the pad. Thus, a collecting pad may be provided that will be relatively light, even though it is provided with parts that are sufficiently sturdy to withstand long-time use, thus also making such a solution economically advantageous.

Advantageously, as specified in claim 36, said barrier parts may be connected to said flexible base pad by means of welding or gluing.

It is obvious, though that the barrier parts may be designed as modular parts that may be connected to the base pad by means of e.g. zip-connections etc.

It will be understood that the barrier parts may be made as integrated parts of the base pad, but the barrier parts may also be configured as separate parts that are connected to the base pad by means of welding or gluing or in other suitable manners.

According to a still further advantageous embodiment as characterized in claim 37, said collecting pad may further comprise cover means for covering an object, e.g. a vehicle, placed on the pad, said cover having at least one opening, through which said object can pass, and closing means for said opening.

Hereby, it is achieved that a system according to the invention may be used for cleaning an object, e.g. vehicle, where it is desired to prevent e.g. water spray from the washing from entering the surroundings, and/or where it is desired to clean an object from foreign matters, including bacterial matter, biological matter etc., for example when a vehicle has been stationed abroad and where the vehicle, before or immediately after is returned, is cleaned thoroughly in order to avoid harmful or undesired contamination.

Finally, the invention relates to a method of treating, cleaning, washing etc. of objects such as vehicles, aircrafts, machines, containers etc., said method comprising the steps of
supplying a collecting pad with barrier means, said collecting pad being stored on a separate handling device, which is transported on a mobile unit,
unloading said handling device,
positioning said handling device,
unrolling said collecting pad from said handling device and moving said handling unit correspondingly,
deploying said barrier means, e.g. inflating inflatable barrier means,
arranging tube connections for transporting collected fluids, e.g. used wash water, from said collecting pad to e.g. a storage tank, and
arranging means for supplying and delivering water for washing and cleaning said object.

Hereby a number of advantages are achieved. First and foremost it is achieved that a wide variety of objects located in different locations may be cleaned, washed etc. using such a mobile unit, while the used wash water may easily be collected and then taken care of, for example stored in a tank on the transport means for later treatment or treated for immediate reuse. Further, since the collecting pad is stored on a separate handling device, it is achieved that a collecting pad may easily be unrolled and deployed at virtually any desired location, irrespective of whether it is possible for e.g. a vehicle to drive to such a location. The handling device may easily be unloaded from the vehicle that is normally used to transport it, and since the handling device is a separate unit, it may be e.g. pushed along the ground to the position where it is desired to locate one end of the collecting pad. Hereafter, the collecting pad may be unrolled from the rotatable element by means of the driving means, while the handling device may be e.g. pushed in the appropriate direction, until the collection pad has been completely unrolled. Following this, the collecting pad may readily be made ready for use, e.g. by inflating the barriers, connecting tubes for the vacuum pumping means etc. As the handling device is a separate unit, it is relatively small in size and relatively easy to move. Therefore, it may be pushed into restricted spaces, for example under aircrafts, under vehicles etc. thus allowing collecting pads to be unrolled directly at a desired location, e.g. under an aircraft or the like.

### THE FIGURES

The invention will be explained in further detail below with reference to the figures of which

FIG. 1 shows in a schematic and perspective view a flexible collecting pad according to preferable embodiments of the invention

FIG. 2a-d illustrate different embodiments of inflatable barriers,

FIG. 3 illustrates a drain pipe arrangement in accordance with the invention,

FIGS. 3a-b show in a large scale a sectional view of a zip connection at the pad,

FIG. 4 shows such a drain pipe located at an edge of the collecting pad,

FIG. 5 shows a drain pipe seen from below,

FIG. 6 shows a further embodiment of the invention in connection with an aircraft, seen from above,

FIG. 7 shows an even further embodiment of the invention, seen from above,

FIG. 8 is a side view of a parked aircraft,

FIG. 9 shows the aircraft from FIG. 8 with a device according to the invention, ready for use,

FIG. 10 illustrates the design of the barrier in a corner of the device according to an embodiment of the invention,

FIG. 11 shows the design of the barrier around a set of landing wheels according to a further embodiment of the invention,

FIG. 12 illustrates a method of using a device according to an embodiment of the invention,

FIG. 13 illustrates the function of a handling device according to an embodiment of the invention,

FIG. 14 shows a mobile system according to an embodiment of the invention, e.g. comprising a trailer completely equipped with the necessary means for treating, e.g. washing an object and collecting the used water, seen in a side view,

FIG. 15 shows the trailer seen in FIG. 14, but from the other side,

FIG. 16 illustrates the unloading of a collecting pad handling device from the trailer,

FIG. 17 illustrates schematically a mobile unit according to an embodiment of the invention, showing the main components comprised in the mobile unit, and

FIG. 18 illustrates in a schematic manner a covering for a collecting pad.

### DETAILED DESCRIPTION

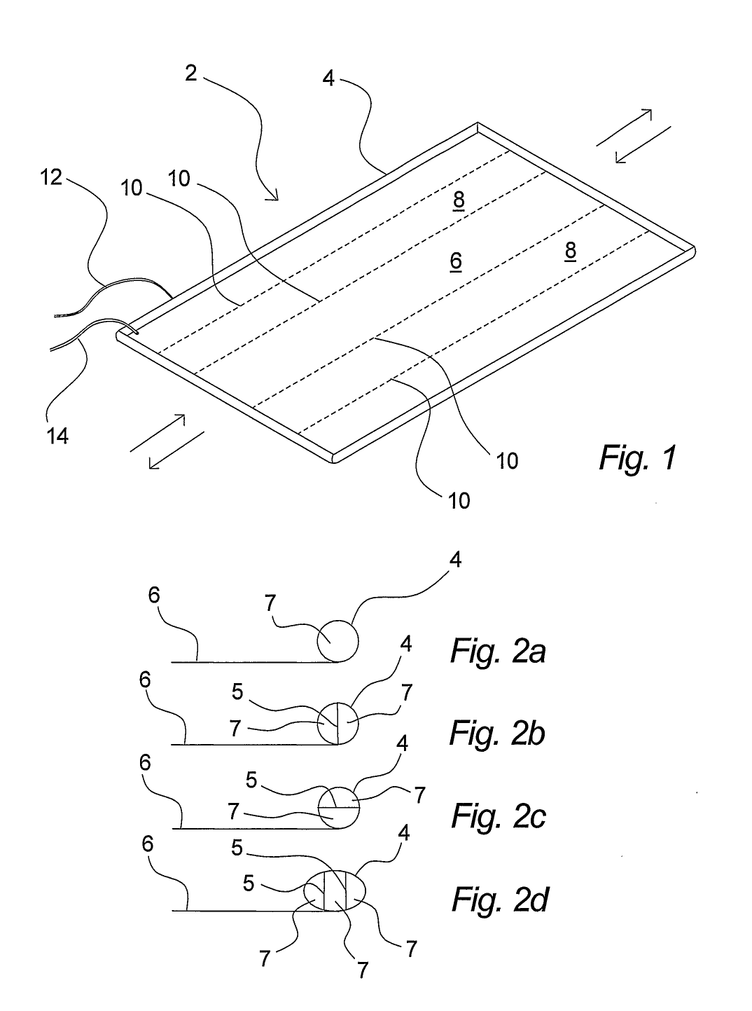

FIG. 1 shows in a schematic and perspective view a flexible collecting pad according to preferable embodiments of the invention. The collecting pad, which is generally designated 2, comprises a flexible base pad 6 and a barrier 4 extending along the perimeter of the flexible base pad 6. The barrier 4 is essentially designed as an inflatable part that may be inflated by means of e.g. a source of compressed air as indicated by the inflating tube 12 that may be connected to a standard inflating nipple or the like (not shown in FIG. 1). Equipment for supplying compressed air etc. will be explained in further detail later on.

The illustrated flexible collecting pad may in accordance with the invention find use for collecting fluids such as wash water, that may contain dirt, oil, soap etc. and for transferring said fluid to e.g. a storage tank or to recycling equipment. For this purpose a suction tube 14 is shown that may be connected to a vacuum pump located on for example a vehicle such as a trailer. The suction tube may be located in different manners in or on the collecting pad, which will be explained in further detail later on.

An object such as a vehicle, a piece of machinery, a trailer with a container, an agricultural machine etc. that has to be cleaned, washed etc., may be driven onto the collecting pad 2 as illustrated by the arrows in FIG. 1, e.g. across the barrier 4 and onto the base pad. It will be understood that the collecting pad 2 will be designed in shape and/or size to correspond to the objects, e.g. vehicles, that has to be cleaned. whereby water that is used for cleaning, for example applied by pressure cleaning equipment a spray washer etc., will run, fall or drip down on the collecting pad 6 within the boundary of the barriers 4. After the vehicle has been cleaned, it may leave the collecting pad 2 again at the same end or at the other end as illustrated by the arrows.

The design of the inflatable barriers 4 will be further explained with reference to FIGS. 2a to 2d that show sectional views of the barriers according to embodiments of the invention. FIG. 2a shows an inflatable barrier that is designed with a single chamber 7 for air. FIGS. 2b and 2c show inflatable barriers 4 that each comprises two air chambers 7, separated by a wall 5 that may be essentially vertical as shown in FIG. 2b or essentially horizontal as shown in FIG. 2c. It is obvious that the wall may be placed in any other suitable manner. Hereby, it is achieved that even if one of the chambers 7 should develop an air leak, the collected fluid will not be allowed to escape to the surroundings. A further embodiment is shown in FIG. 2d, where an inflatable barrier is shown with three separate chambers. It is obvious that more than three chambers 7 may also be employed and that numerous configurations of chambers 7 and walls 5 are possible in accordance with the invention.

As further illustrated in FIG. 1, the collecting pad 2 and in particular the flexible base pad 6 may comprise a number of parts that in assembled form compose the collecting pad 2. As shown, the base pad may comprise two modular parts 8 that are connected to the other parts by means of connections 10. The modular parts 8 may be placed at locations where e.g. wheels of vehicles will pass and be parked, thus making it possible to exchange these parts for new parts when they are worn down. In accordance with the invention, modular parts may also be connected to each other in order to compose a collecting pad of a desired size and/or shape. Thus, it will be understood that the configuration shown in FIG. 1 is only an example of a modular configuration. For example, the modules may be connected to each other not only in the width, but also lengthwise. The connections 10 are preferably designed in a substantially fluid-tight manner and may comprise zip-connection means, Velcro fastening parts etc.

The inflatable barriers 4 may be connected to the base pad 6 in numerous manners, for example by welding, gluing, etc. and further, the barriers 4 may be connected to the base pad in a reversible manner, e.g. using zip-fastening parts etc. Further, it will be understood that the barriers 4 also may be designed as parts integrated with the base pad 6, e.g. made from the same sheet of material etc.

The inflatable barriers 4 may be connected to each other along the circumference of the base pad, thereby making it possible to inflate each chamber 7 at one location only. However, it is evident that the barriers 4 may be divided along the circumference of the base pad 6, for example at the corners, thus requiring the inflatable barriers to be inflated one at a time or requiring more than one tube for compressed air to be used.

As explained above, the collected fluid is transferred from the pad 2 by means of a vacuum pump and a flexible tube 14 that may be placed in the collecting pad at a suitable location or at suitable locations, if more than one suction tube is used. Further, the collecting pad may comprise special means for draining the collecting pad, for example in the form of one or more pipes that are integrated with the pad, which will be illustrated later on.

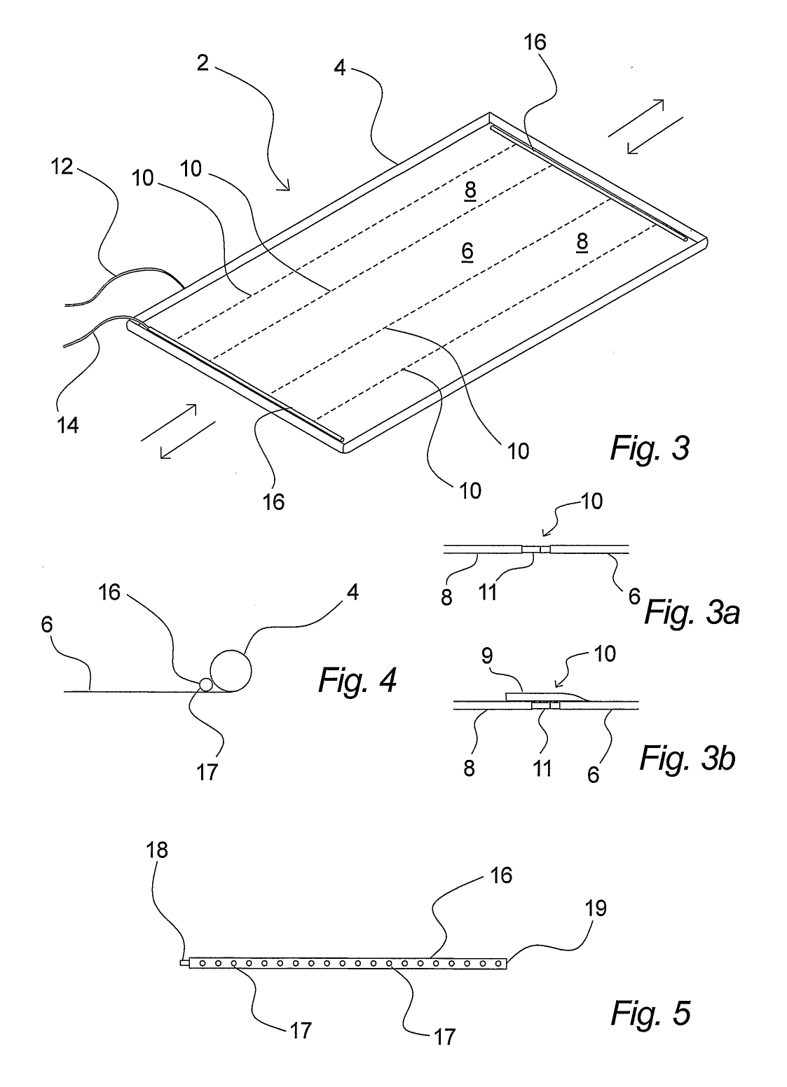

However, in a preferable form, as illustrated in FIG. 3, the collecting pad 2 may be equipped with a drain tube or drain pipe 16 that may be placed at one or both ends of the collecting pad 2. This drain tube extends essentially along the end barrier or barriers 4, e.g. across the width of the collecting pad 2. The drain pipe 16 may be placed as shown in FIG. 4, and as indicated the drain pipe 16 has inlet openings 17 in the lower part of the drain pipe 16. These inlet openings 17 may be designed as shown in FIG. 5 that illustrates a drain pipe seen from below. Thus, the inlet openings may be holes that are spaced with regular intervals. The drain pipe may be constructed from a rigid or a semi-rigid pipe or tube that is equipped with an end plug 19 at one end and a connector 18 at the other end for the suction tube 14. The drain arrangement comprising such a drain tube 16 has the advantage among others that the collected water may be transferred from any point along the end of the collecting pad 2 and further the collecting pad 2 may be rolled up for storage without any difficulty when such an arrangement is used, which will explained in further detail below.

A zip connection 10 between parts making up the flexible collecting pad 2 is illustrated in FIGS. 3a and 3b, showing a sectional view in a large scale of a zip connection 11 between two modular parts 6 and 8. In FIG. 3a, the two parts 6 and 8 are equipped with zip connection means 11 at the edges, e.g. as integrated parts of the modules, and these connection means are illustrated connected together. This connection will in itself be fluid-tight since the zip-connection means are designed with sealing means and/or are manufactured from a material that is flexible enough to provide a sealing effect. In FIG. 3b, a similar connection is illustrated, but here, one of the modules 6 comprises a flap 9 that may overlap the zip connection when it has been closed in order to improve the fluid-tightness and the strength, e.g. in order to reduce wear from e.g. tires etc. that may travel across the zip connection 10.

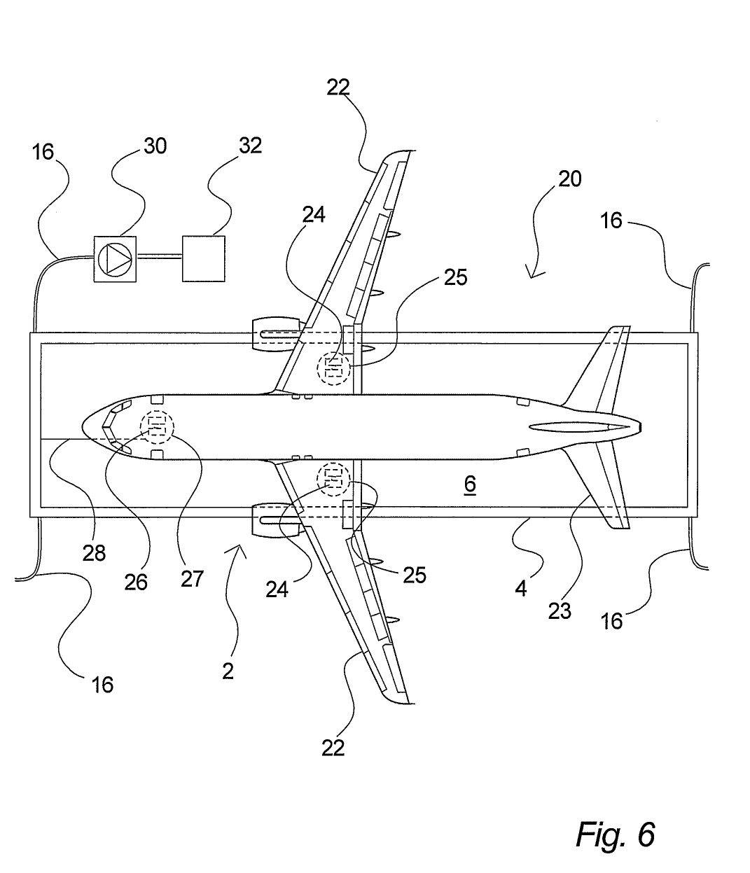

A further embodiment of the invention will be explained with reference to FIG. 6 that shows an aircraft 20 seen from above in connection with a flexible collecting pad 2 in accordance with the invention. The collecting pad 2 is shown laid out under the aircraft, e.g. placed under the body of the aircraft and under the inner parts of the wings 22 and the stabilizer 23. As explained above, the collecting pad 2 comprises a barrier 4 along the perimeter of the flexible base pad 6. Further, in connection with the landing gear 24 and 26, landing gear barriers 25 and 27, respectively, are placed around these parts as indicated with punctuated lines. These barriers 25 and 27 will later be described in further detail. At the landing gear 24 under the wings 22, the barriers 25 may be arranged in connection with the barrier 4 at the edge of the base pad 6. In connection with the barrier 27 surrounding the landing gear 26 under the nose of the aircraft, an incision 28 of the base pad 6 may be arranged as shown in FIG. 6. This incision 28 is preferably designed to be fluid-tight.

In connection with the embodiment shown in FIG. 6 tube connections 16 may be arranged at each corner of the collecting pad 2, and as shown for one of these, a vacuum pump 30 may be connected to each of these connections 16, whereby fluid such as water etc. may be transferred, e.g. pumped further on to a storage tank 32 or similar means, for example a tank on a vehicle. It will be understood that a pump 30 may be arranged for each tube connection, but according to a preferred embodiment a plurality of these tube connections are connected to one and the same pump 30.

Further, the transferred water may be led to a device for cleaning the waste water. The cleaned water may naturally be led out to e.g. a sewage system, since the risk of environmentally pollution will be reduced if not completely prevented, but preferably the cleaned water may be reused for cleaning, whereby the water consumption will be greatly reduced.

With the embodiment shown in FIG. 6, washing etc. of e.g. the body of the aircraft as well as parts of the wings and the stabilizer may be performed while water, wash detergents etc. will be collected by the collecting pad 2 since the fluids will be prevented in escaping by the barriers 4, 25 and 27. The collected fluid may be transferred from each corner as indicated. However, in this connection it is noted that due to an unavoidable declination, the collected fluid will tend to flow towards one or two of the corners. If the declination is know in advance, it will suffice to arrange suction of the collected fluid from one or possibly two of these corners or from an end of the pad 2.

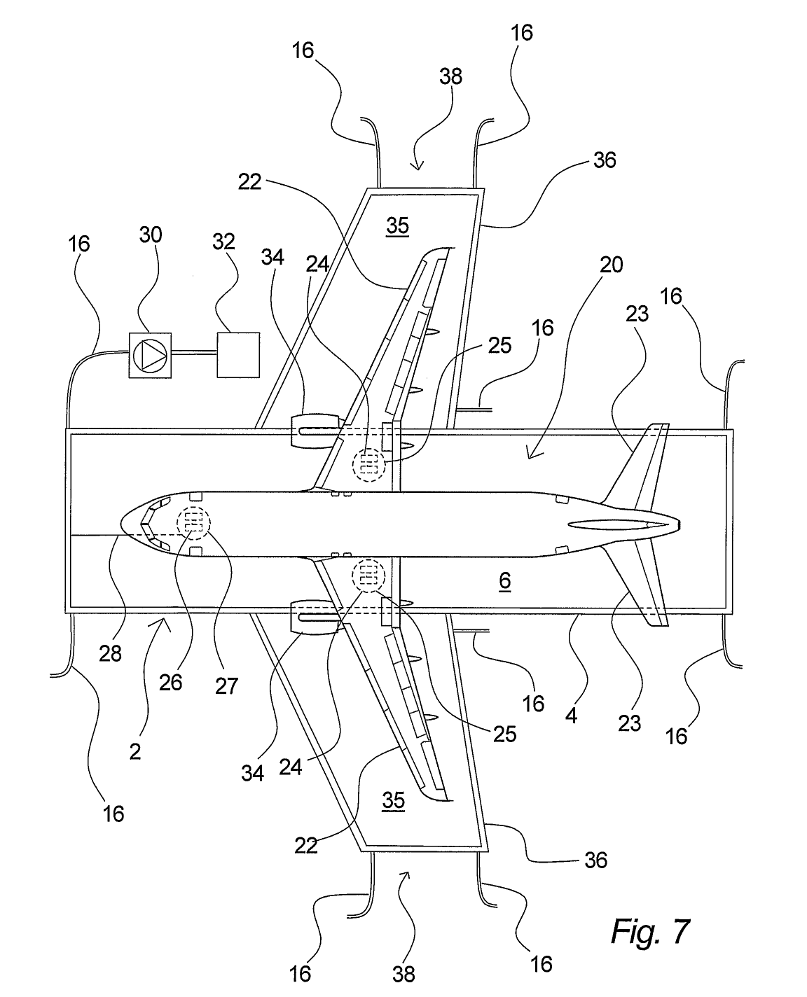

In FIG. 7 an embodiment corresponding to the embodiment described above in connection with FIG. 6 is illustrated. However, this embodiment further has supplemental collecting pads 38, one for each wing 22. These further collecting pads 38 are arranged in a similar manner to the collecting pad 2, i.e. with flexible base pads 35 and barriers 36 extending along the perimeter, possibly also along the edge that abuts the collecting pad 2 under the aircraft body.

It will be understood that the further collecting pads 38 can be connected to the collecting pad 2, possibly in such a manner that fluid etc. may flow between the respective parts, possibly via pipes, tubes etc. However, these collecting pads may be separate and may only be connected mechanically. As shown, tube connections 16 may also be arranged at the corners of the further collecting pads 38 for transferring of the collected fluid.

It is also evident that a collecting pad in accordance with the invention may be designed as a continuous part, by means of which fluid from the entire aircraft may be collected, e.g. corresponding to the extent of the collecting pads 2 and 38 in FIG. 7. For practical reasons, including weight, ease of handling etc. a design with a plurality of parts may be preferable, though.

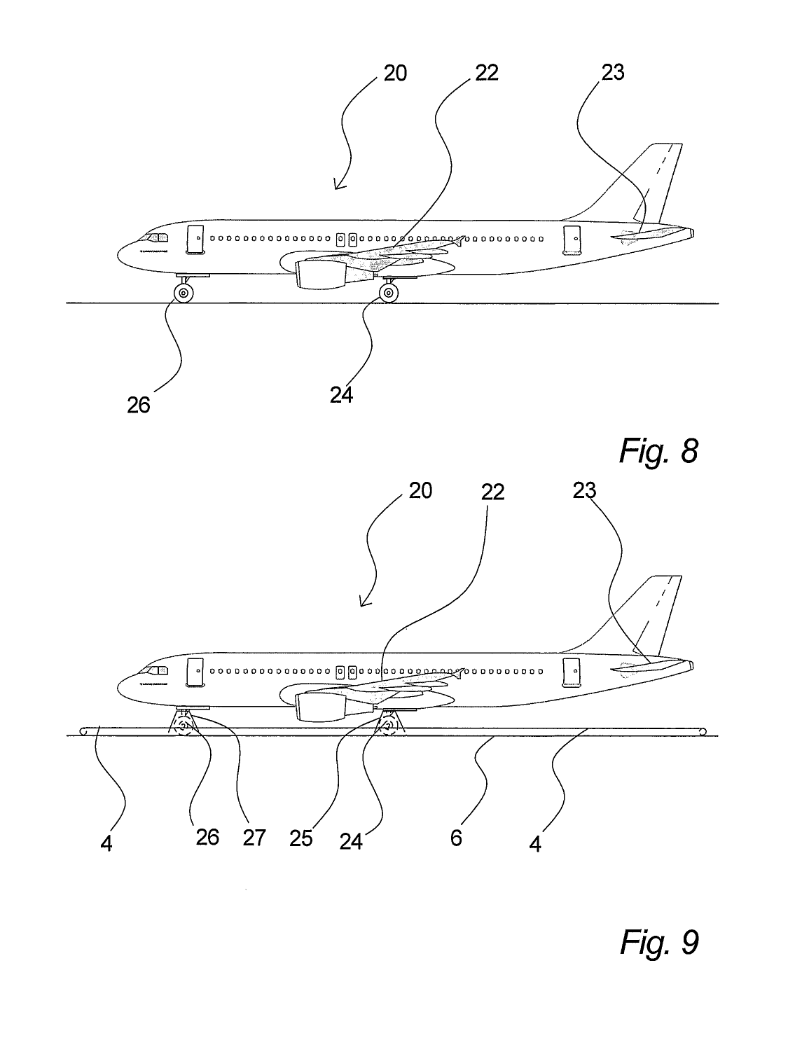

A collecting pad in accordance with the invention will be illustrated in further detail with reference to FIGS. 8 and 9 that show an aircraft in a side view, parked e.g. on the airport ramp.

As shown in FIG. 9 a flexible collecting pad is arranged under the aircraft 20 in such a manner that the flexible base pad 6 is arranged on the ground with the barrier 4 surrounding the base pad 6. As also illustrated, the landing gear 24 and 26 are surrounded by barriers 25 and 27, respectively, which as shown may be in the form of shielding that encloses the landing gear and is tilted upwards in such a manner that e.g. wash water cannot escape here.

It will be understood that the flexible base pad 6 need not extend under the landing gear 24 and 26 according to this embodiment, but only in the vicinity of the landing gear. In this manner, the collecting pad may be unrolled and/or unfolded under the aircraft and placed appropriately without moving the aircraft.

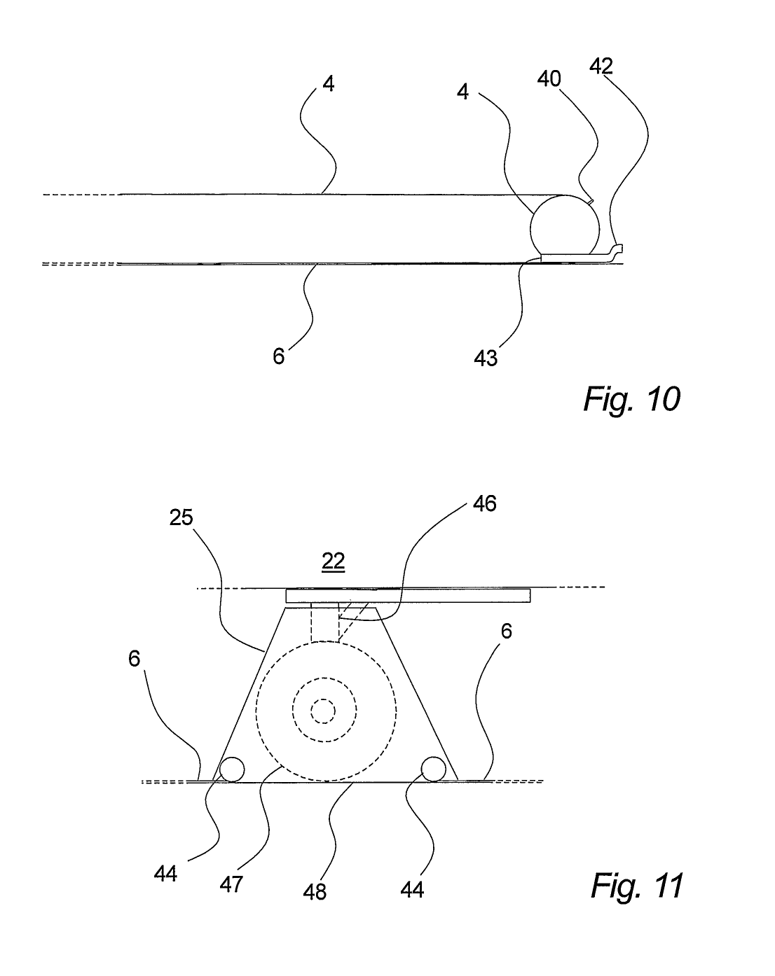

In FIG. 10 a barrier 4 placed on a base pad 6 is shown in a sectional view. This view shows the barrier in the vicinity of a corner, where the barrier thus also will extend to the left in FIG. 10. As shown, the barrier may be in the form of a tube, possibly made in the same material as the flexible base pad 6, and may as explained above be inflated with air. Thus, the barrier may be equipped with one or more air nipples 40 for providing a connection to a source for air such as a compressor. As also mentioned above, the barrier may be divided into separate chambers, for example in the longitudinal direction. As shown, the collecting pad may be constructed with a passage 43 in the form of a tube or pipe in the corner for transferal of the collected fluid. This passage 43 may pass the barrier 4 and enter the collection pad right above the flexible base pad 6. Outside the barrier 4 the passage 43 may have a connector 42 for a tube. Instead, a drain pipe or tube 16 may be arranged as explained above in connection with FIG. 3.

It will be understood that the height of the barrier 4 need not necessarily be large, since the collected fluid is constantly being pumped away. Thus, large amounts of water will not be collected, not even in the lower corners and edges. The function of the barrier is thus to assure that water etc. will not escape, but be collected and pumped away. Thus, the barrier need not be able to withstand excessive pressure or impact.

A configuration of the barrier in accordance with a particular embodiment of the invention will be described in the following with reference to FIG. 11. Here, the area in the vicinity of the landing wheel 47, which via the landing gear 46 supports the aircraft on the ground, e.g. the runway, the ramp or the like, is shown. The flexible base pad 6 has a cut-out or incision in the area around the landing wheels 47, and as mentioned above, a cover-shaped barrier 25 can be placed around the landing wheels 46. This cover-shaped barrier 25 may be manufactured from a relatively flexible material, for example tarpaulin or the like, which is folded around the landing gear in such a manner that the sides are tilted outward and in such a manner that the upper edge is located close beneath the aircraft body. The function of this barrier is to lead water etc. that drips or flows down from the aircraft, down towards the flexible base pad 6 in such a manner that the water cannot escape via the cut-out or the incision in the base pad. It will thus be understood that the barrier 25 does not necessarily have to be particular fluid-tight, and the barrier may be designed from a single piece of material that may be folded around the landing gear 46 and 47 and overlapped, for example held in place by means of a Velcro connection or the like. The cut-out in the base pad 6 may be equipped with a circumferential barrier 44 that may be designed in a manner similar to the barrier 4, e.g. inflatable, or it may be configured as a full body comprising foam or a similar material. This barrier 44 serves to prevent water etc. that is led down the barrier 25 from escaping onto the runway or the ground 48.

In this connection it should be mentioned that other cut-outs, incisions or the like in the base pad, for example the incision 28 shown in FIGS. 6 and 7 may be designed in a similar fashion in order to prevent leakage. For example, along the incision 28 barriers may be provided at both sides, which barriers may be inflatable, solid etc. and possibly such barriers may be connected to the barrier 4 that surrounds the flexible base pad 6. The incision 28 may also be fabricated in other manners in order to be fluid-tight, e.g. with fluid-tight connections as explained above, e.g. with zip-connecting means, Velcro fastening means etc.

Further, it should be mentioned that the barriers 25 may be designed as parts that are integrated with the base pad 6, e.g. as a piece of materiel connected to the base pad 6 and with means, e.g. a zipper, in order to connect the two edges of such a piece of material with each other when it has been folded around the landing gear.

In a similar manner the barriers 25 around the landing wheels 24 may be manufactured in connection with the barrier 4 that is located close to the landing gear 24 here, as illustrated in FIG. 6. The cut-out or incision in the base pad 6 may thus extend to the edge of the base pad 6 and the barrier 4 may be connected to the circumferential barrier 44 (FIG. 11), whereby inflating etc. of these barriers may be performed simultaneously.

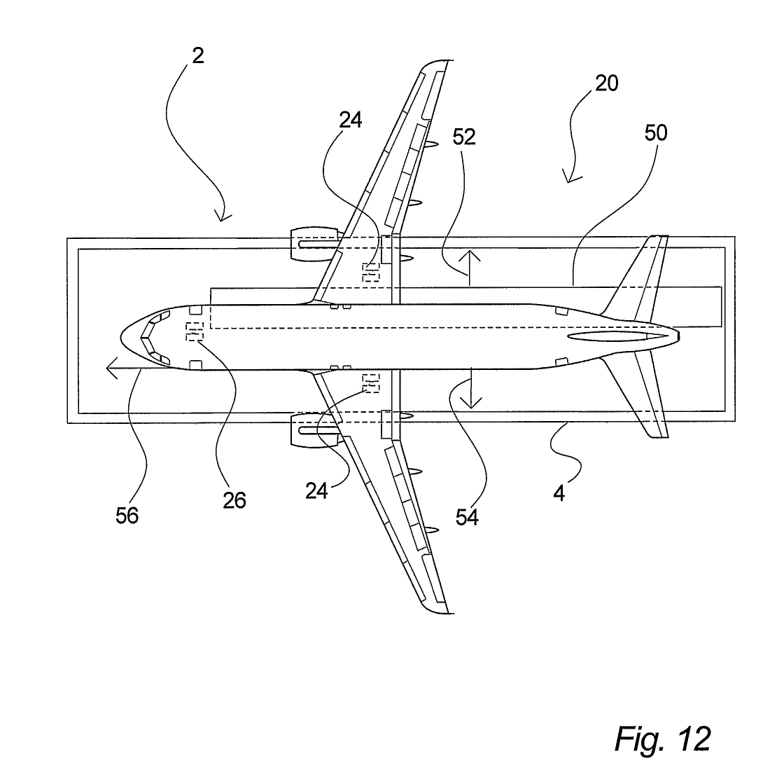

A method of utilizing a collecting pad according to an embodiment of the invention will be explained in further detail in the following with reference to FIG. 12 that in a manner similar to FIGS. 6 and 7 shows a parked aircraft 20 seen from above. The rolled-up or folded-up collecting pad according to the invention may initially be placed under the aircraft 20 and unrolled in the axial direction of the aircraft as shown at 50, extending to the front landing gear 26 and between the rear landing gear 24. The manner, in which the pad may be unrolled, will be explained in further detail later on. After the pad has been unrolled as shown in FIG. 12, it may be unrolled or unfolded further to the sides as shown with the arrows 52 and 54. During this operation the pad may be placed on both sides of the landing gear 24, since the pad may be provided with incisions as previously explained. Hereafter, the pad may be unrolled or unfolded further forwards as shown with the arrow 56. Simultaneously, the pad is positioned on both sides of the landing gear 26, e.g. due to the incision (28; FIG. 6).

In this manner, the pad 6 will now be completely unrolled/unfolded to the final form and shape, and the inflatable barriers 4 may be inflated. Other barriers, e.g. 25 and 27, may be erected and connected around the landing gear 24 and 26. Finally, tubes 16 may be connected to possible connections provided, e.g. 18 (FIG. 5) or 42 (FIG. 10) for establishing the connection to a vacuum pump, a storage tank etc. Thus, the system will now be ready for use, e.g. the pad 2 will be ready to collect used wash water, detergents, cleaning agents etc., which will be transferred to a storage tank and/or to a recycling system.

It will be understood that the pad may be designed in such a fashion that it may be able to collect water etc. also from the wings, e.g. with a form corresponding to the form shown in FIG. 7, or it may be configured as explained in connection with FIG. 7 with supplemental collecting pads 38. These pads 38 may in a relatively simple manner be unrolled or unfolded and made ready for use, e.g. including inflating of barriers, connection of possible tubes and possibly mechanical fixing to the collecting pad 2.

It is noted that a collecting pad according to the invention may be used in connection with a great number of aircraft types and sizes and that one and the same pad may be used in connection with different types of aircraft. It will be understood, though, that a pad may be provided in different sizes, each one corresponding to an interval of aircraft sizes.

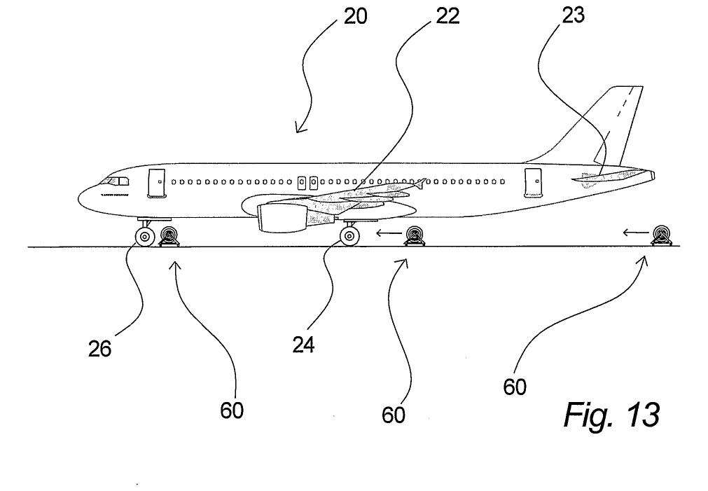

A method of using a handling device according to the invention will now be further explained with reference to FIG. 13. Here, an aircraft 20 is shown in a side view, parked on the ground. A handling device 60 with a rolled up collecting pad has been unloaded from a vehicle such as a trailer (not shown in FIG. 13) behind the aircraft 20 as shown at the right side in FIG. 13. The handling device 60, which will be described in further detail later on, is equipped with wheels and may then be pushed (as illustrated in FIG. 13) under the aircraft, e.g. between the pair of landing gear 24, as shown until it is in a position near the front landing gear 26. Here, the collecting pad may be unrolled, e.g. a rotatable element on the handling device 60 is made to unroll the collecting pad and simultaneously the handling device is moved backwards, e.g. at a pace corresponding to the speed with which the collecting pad is unrolled, until the collecting pad is completely unrolled. Hereafter, the collecting pad is further unfolded or unrolled, e.g. further forward and/or to the sides as explained in connection with FIG. 12, and deployed for use. After use, the procedure may be reversed, i.e. the barriers may be deflated etc., the collecting pad may be folded into a strip that corresponds to the width of the handling device, and the rotatable element on the handling device may be started in order to roll up the collecting pad. As the pad is rolled up on the handling device, the handling device may be pulled in the direction under the aircraft, which will further have the advantage that the pad will be rolled firmly on the handling device. After the pad has been rolled up, the handling device is pushed backwards again (or sideways) until it is in a position where it can be loaded on the trailer again. It is noted that the handling device has a size, e.g. a height, that makes is possible to push it in under the aircraft, and e.g. a width that makes it possible for the device to pass between the landing gear 24, whereas a trailer or another vehicle with the necessary equipment will not be able to pass under the aircraft.

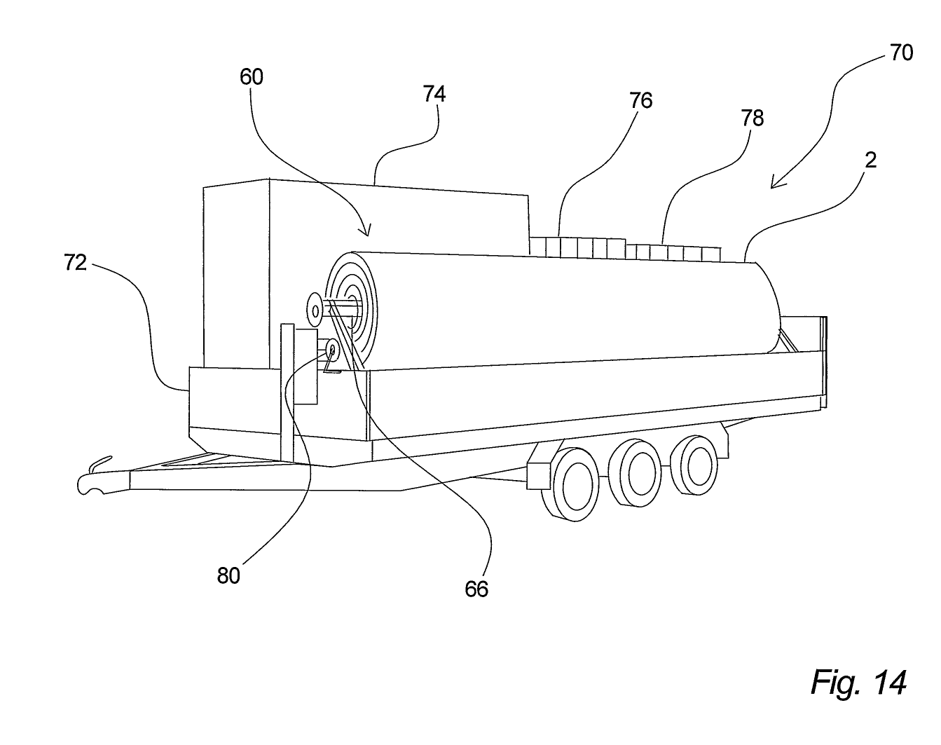

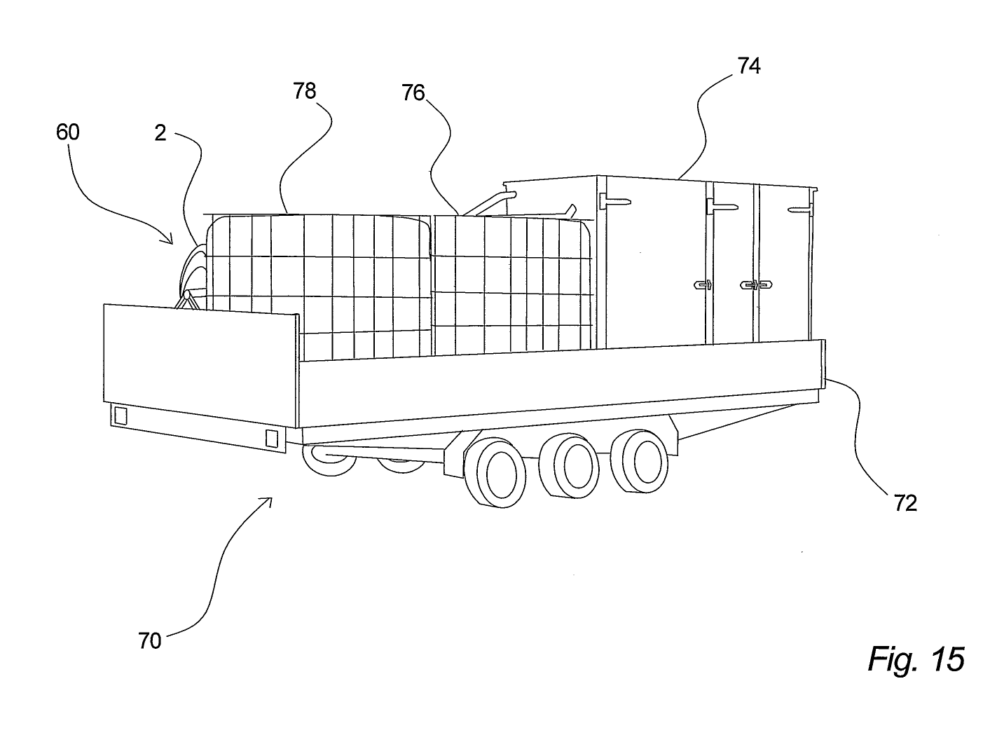

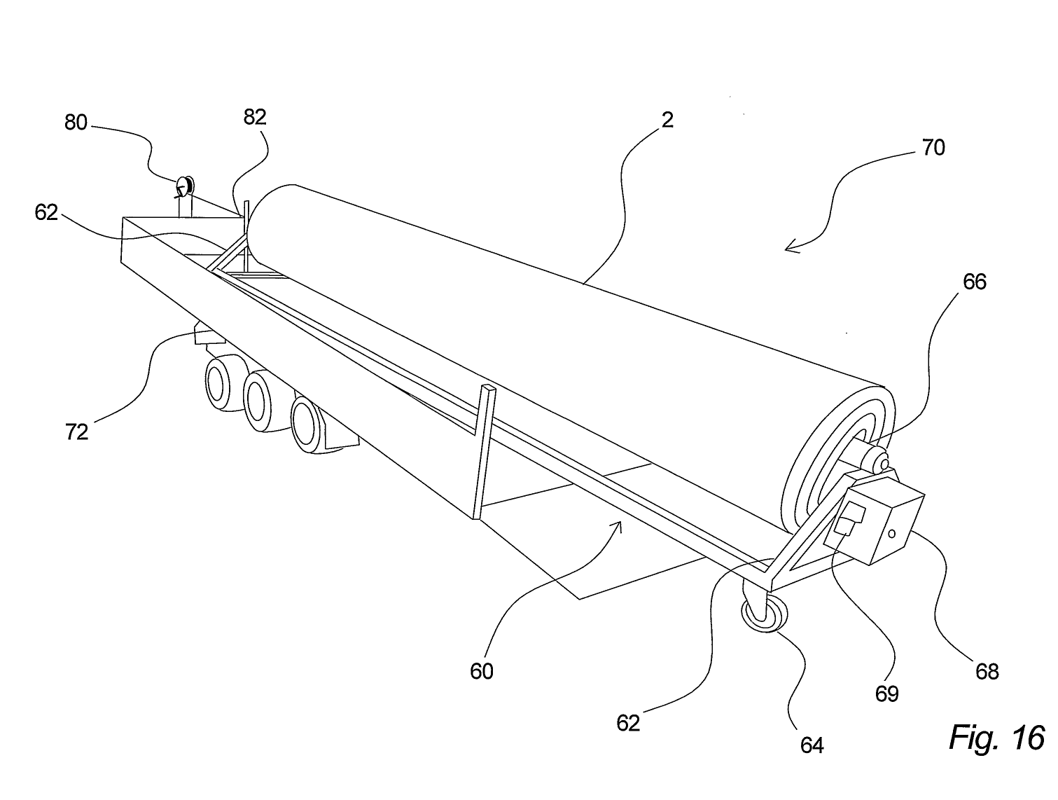

A handling device 60 and a mobile unit 70 will now be further described with reference to FIGS. 14, 15 and 16. Here, a trailer 72 is shown with the necessary equipment for cleaning, e.g. washing an object such as a vehicle, a boat, a container, an aircraft or another type of machinery or object.

The handling device 60 may be seen in detail in FIG. 16, where the trailer is shown with the carrier in a tilted position (and where the other pieces of equipment have been omitted for the sake of clarity). The handling device 60 comprises a frame 62, which is supported by four wheels 64. The frame 62 carries a rotatable element 66 for storage of a collecting pad 2, which rotatable element 66 may comprise a drum, a shaft or the like. This rotatable element 66 is driven by drive means 68, preferably in the form of an electric motor that is reversible. This electric motor may be driven from a battery or as shown it may be supplied with energy via a power cable that may be connected to the plug 69. The power cable (not shown) may be connected to a domestic supply or may preferably be connected to an electric generator, e.g. a generator driven by a combustion engine placed on the trailer 72. Further, it is noted that drive means may also be arranged for the handling device itself, e.g. an electric drive for e.g. two of the wheels 64. Finally, the handling device 60 is equipped with means for facilitating the loading and unloading. As shown, the trailer 72 may be equipped with a tiltable carrier and a hoist 80. This hoist 80 may as shown be manually driven but may also be driven by means of an electric power drive, hydraulics etc. Further, the handling device is equipped with a connector 82 for the hoist. Thus, it will be understood that when the carrier is tilted, the handling device 60 may by means of the hoist 80 be allowed to move downwards to the ground and vice versa, when the handling device is loaded onto the trailer again. It will be obvious to the skilled person that other hoisting means may be used instead. For example, the handling device 60 may be unloaded from the side of the trailer 72, e.g. by means of two hoists that may be arranged in order to move the handling device 60 out from the trailer and down. Also, the trailer need not be equipped with a tiltable carrier.

It is further noted that a mobile system 70, e.g. a trailer 72 may comprise two or more handling devices 60 with collecting pads, if necessary.

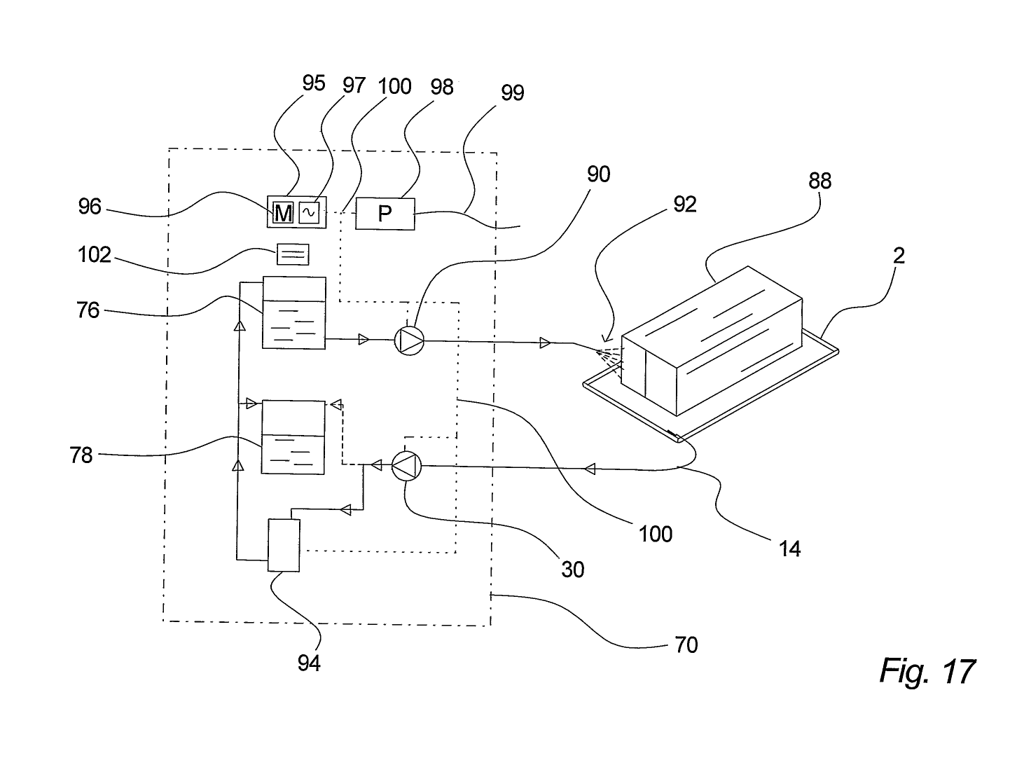

The mobile unit 70, e.g. the trailer 72 with equipment, is as shown in FIGS. 14 and 15 provided with one or more casings or cabinets 74 for equipment, which casing(s) may contain the electric generator, the compressor (for inflating the barriers), the pressure cleaning equipment, the vacuum pump and other necessary or optional equipment such as tubes, water cleaning facilities etc. Further, the trailer 72 is provided with a tank 76 for water, e.g. water for washing, and a tank 78 for storage of collected fluid. As also explained above, the mobile unit may be equipped with a water reuse arrangement (illustrated in FIG. 17) in which case water from the tank 78 may be led to this water reuse arrangement, where after the filtered and cleaned water may be led to the tank 76.

Further, the tanks 76 and 78 may preferably be exchanged, e.g. when an object has been washed, the tanks may be unloaded using e.g. a forklift truck, and a new tank 76 with fresh water and a new empty tank 78 for collected fluid may be loaded onto the trailer 72. The tank 76 that has been unloaded may now be filled with water again, and the tank 78 with collected dirty water may be emptied for water that may be processed, e.g. cleaned before being e.g. led into the sewer. In this manner the mobile unit may quickly be made ready for use again.

In FIG. 17 a mobile unit according to an embodiment of the invention is further illustrated in a schematic manner, showing the main components comprised in the mobile unit, which is generally illustrated by the dash-dotted box 70. In the figure, a collecting pad 2 in accordance with the invention is shown with an object 88, such as for example a container as shown, placed on the collecting pad. It will be understood that the collecting pad 2 has been deployed using a handling device as described above, even though this handling device is not illustrated in FIG. 17. The object 88 is cleaned with the use of cleaning equipment 92 such as for example a spray washer, a pressurized water cleaner, etc., which is supplied with water via a water pump 90 from a fresh water tank 76.

The cleaning equipment 92 may be designed in numerous manners, which will be obvious to a skilled person, and it will be understood that cleaning agents, soap, etc. may be added to the cleaning liquid and/or that the cleaning liquid, e.g. water, may be heated before use, e.g. by using electric heating equipment. The used, e.g. dirty water is collected by the pad 2 and via the connecting tube 14 and a vacuum pump 30 the dirty water is transferred to the mobile unit 70, e.g. the mobile unit comprising for example a trailer.

The dirty water may be pumped directly to a storage tank 78 as explained above and as shown with the dash-line, but instead the water may be delivered to a water treating unit or arrangement 94. Such a water treating unit 94 may be designed in various manners using mechanical means such as e.g. filters, separators etc. and/or chemical means, which will be obvious to a skilled person, Further, such a water treating unit 94 may be designed in order to clean the water to a certain degree and in consideration of the nature of the contaminated water, e.g. whether the water contains oil, sand, dirt, cleaning agents etc, and in consideration of, whether it is allowable that the treated water may contain residues of such matters.

From the water cleaning or treating unit 94 the water may be led to the storage tank 78 or it may as shown be led directly to the fresh water tank 76 for re-use as explained above. Obviously, if the water is led to the storage tank 78, it may also be re-used, for example if a connection is established between the two tanks. Possibly, one tank may suffice, if the treated water may be led directly to the fresh water tank.

Further, an electric generator unit 95 is also shown in FIG. 17. Such a generator unit may for example comprise a combustion engine 96 that is connected to an electric generator 97, e.g. a single- or three-phase AC-generator. The generator supplies electric power via power lines 100 (shown with dot-lines) to the components that need electric power, e.g. the pumps 30 and 90, an air compressor 98, which serves to supply compressed air via tubing 99 to the inflatable barriers etc., possibly the water treating unit 94, and possibly also the handling unit for the collecting pad, etc. It is also illustrated in FIG. 17 that the mobile unit may comprise an electric battery 102 that may be charged by means of the electric generator unit 95, and that may serve as power source for certain equipment, such as e.g. an electric hoist that may be used for loading and unloading the handling unit for the collecting pad etc. The battery 102 (or a separate, additional battery) may also serve as a power supply for the handling unit for the collecting pad as described above.

It is obvious that the mobile unit 70 may comprise further components and equipment as previously explained. Further, even though a handling device is not illustrated in FIG. 17, it will be understood that such a device is also comprised as a part of the mobile unit, cf. e.g. FIGS. 14-16, and has been used for deploying the collecting pad shown in FIG. 17. With the illustrated construction the mobile unit according to the invention may be used completely independent of for example electric power sources, water supply etc. Further, as also explained above, the mobile unit 70 may be placed in a container, e.g. a 20 foot container, and transported, e.g. shipped or sent by air, to a place where it is needed, and where the cleaning unit according to the invention thus may quickly and efficiently be provided and made ready for use. In case the mobile unit incorporates a trailer, it is only necessary to provide a car, a truck or the like in order to operate the system.

As explained, the invention may find use in other applications than specifically mentioned above, such as in connection with other large machinery, developer machinery, etc. with only simple adjustments and modifications, which will be evident to the skilled person. Thus, with a collecting pad according to the invention it will also be possible to clean such machines without having to establish special constructions, washing arrangements etc. for collection of the water that may contain oil and fuel as well as other matter that may be damaging to the environment.

Similar will apply as regards washing, cleaning and/or other treatment of boats or vessels such as for example recreational vessels etc. that may be located on land. For example, a boat or a vessel up to a certain size may be lifted up on land, where it may be supported, either on the ground or on a trailer, a lorry or the like, where washing, cleaning etc. may be performed on the actual location as explained above in connection with vehicles, aircrafts, etc.

Further, the invention may find use for washing, cleaning and/or other treatment of a container. For example, such treatment may be performed on containers for many different purposes, such as containers for sea, land or air transport, for which containers there normally will not be any suitable possibilities for performing such treatment. This may expediently take place when using the invention, for example in harbours, airports and similar locations.

Still further, the invention may find use for washing, cleaning and/or other treatment of agricultural machines and equipment, vehicles and equipment for industrial use etc.

Finally, it is noted that the invention may find use in connection with a wide variety of, what may be designated as being large objects, for example objects as mentioned above. However, these examples are only illustrative and are not exhaustive.

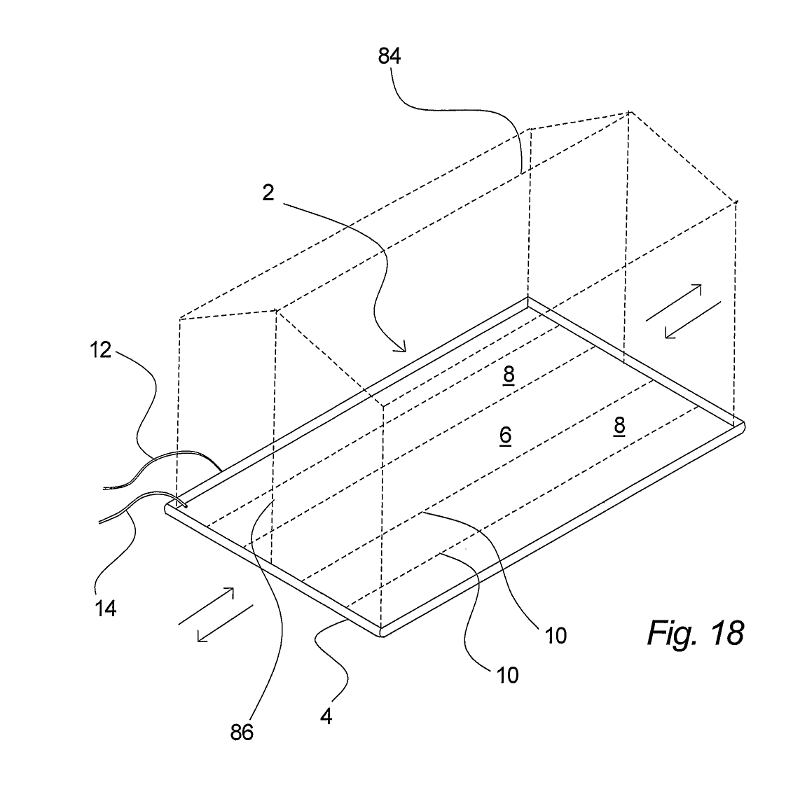

A further use of a collecting system according to the invention is illustrated in FIG. 18. Here, a collecting pad 2 is shown with a covering that is generally designated 84 assembled on top of the pad 2. The covering 84 may be manufactured from the same material as the flexible pad 2, and it may be connected to the pad 2 by means of zip connection means or other connecting means. The covering is designed with an opening 86 at one or both ends.

Hereby, the system according to the invention may be used for cleaning an object, e.g. vehicle, where it is desired to prevent e.g. water spray from the washing from entering the surroundings, and/or where it is desired to clean an object from foreign matters, including bacterial matter, biological matter etc., for example when a vehicle has been stationed abroad and where the vehicle, before or immediately after is returned, is cleaned thoroughly in order to avoid harmful or undesired contamination. Other uses may for example be when an object in general has been subjected to harmful matters or when it is feared that such a contamination might have taken place, and where it is necessary—at least as a precautionary measure—to clean the object under such conditions where it is prevented that any harmful matter is allowed to escape to the surroundings.

It will be understood that the invention is not limited to the particular examples described above and shown in the drawings but may be modified in numerous manners, used in a wide variety of applications and manufactured in materials commonly used within the field. Thus, it will be understood that the collecting pad, the handling device and the mobile unit according to the invention may be designed in a multitude of varieties within the scope of the invention as specified in the claims.

### LIST OF REFERENCES

2 Collecting pad
4 Inflatable barrier
5 Interior wall in barrier
6 Flexible base pad
7 Air chamber
8 Module part for base pad
9 Overlap at connection
10 Connection between modules
11 Zip connection
12 Inflating tube
14 Connecting tube, suction tube
16 Drain pipe for suction tube
17 Suction holes in drain pipe
18 Connector for tube
19 End plug
20 Aircraft
22 Wings on aircraft
23 Stabilizer
24, 26 Landing gear
25, 27 Barrier around landing gear
28 Incision
30 Pump
32 Collecting tank
34 Aircraft engine
35 Flexible pad or underlay
36 Barrier around further collecting pad
38 Further collecting pad
40 Nipple for inflating
42 Connection for tube
43 Passing pipe
44 Surrounding barrier at landing wheel
46 Landing gear
47 Landing wheel
48 Runway, ground, ramp or the like
50 Pad, partially unrolled
52, 54, 56 Directions for unrolling the pad
60 Handling device for collecting pad
62 Frame
64 Wheels
66 Rotatable element for storage of collecting pad
68 Drive means for rotatable element
69 Plug for electric power supply
70 Mobile unit
72 Trailer
74 Casing for equipment
76 Water tank
78 Tank for storage of collected fluid
80 Loading/unloading gear, hoist
82 Connector for loading gear
84 Cover for collecting pad
86 Opening in cover
88 Object to be cleaned, e.g. a container
90 Water pump
92 Cleaning equipment, e.g. pressurized water cleaner
94 Water treating unit
95 Electric generator unit
96 Combustion engine
97 AC generator
98 Air compressor
99 Compressed air tube
100 Electric power supply lines
102 Electric battery

1.-38. (canceled)

39. Mobile unit for treating, cleaning, washing etc. of objects such as vehicles, aircrafts, machines, containers etc., said mobile unit comprising:
transport means,
a flexible collecting pad with barrier means including inflatable barrier means,
means for supplying air for inflating said inflatable barrier means,
transferring means for fluids collected on said collecting pad,
a storage tank for collected fluids,
a storage tank for fluid for washing said object,
means for delivering and applying said fluid,
wherein said flexible collecting pad is stored on a separate handling device that is movable in relation to said transport means, and
wherein said mobile unit comprises means for facilitating loading and unloading of said handling device.

40. Mobile unit according to claim 39, wherein said transport means comprises a trailer.

41. Mobile unit according to claim 39, wherein said mobile unit comprises an electric generator.

42. Mobile unit according to claim 39, wherein said mobile unit comprises means for reusing said collected fluid, said reusing means comprising filtering means.

43. Mobile unit according to claim 39, wherein said transferring means for fluids collected on said collecting pad comprises a vacuum pump.

44. Mobile unit according to claim 39, wherein said separate handling device for storage and handling of said flexible collecting pad, said collecting pad being designed for collecting of a fluid such as water, comprises
means for storage of said pad on a rotatable element such as a drum or a shaft,
a frame for carrying said means for storage of said pad, said frame having supporting wheels, and
means for driving said rotatable element in relation to the frame, wherein
said handling device is adapted for transport by a vehicle, and
said handling device is separately movable.

45. Mobile unit according to claim 44, wherein said means for driving said rotatable element in relation to the frame comprises an electric drive motor.

46. Mobile unit according to claim 44, wherein said means for driving said rotatable element in relation to the frame is designed for reversing the drive direction.

47. Mobile unit according to claim 44, wherein said handling device comprises means for moving the handling device, such as drive means supported by the frame and connected to at least one of said supporting wheels.

48. Mobile unit according to one or more of claims 44, wherein said handling device comprises means for facilitating unloading of the handling device from a vehicle and loading of the handling device onto the vehicle.

49. Mobile unit according to one or more of claims 39, wherein, said collecting pad comprises
a flexible base pad and
barrier parts extending essentially along a periphery of said flexible pad, said barrier parts being at least in part accommodated for folding and comprising inflatable parts, and
wherein said inflatable parts that form part of said barrier parts are designed as longitudinally extending parts comprising at least two chambers extending along each other.

50. Mobile unit according to claim 49, wherein said inflatable parts of said collecting pad comprise an essentially vertical wall member extending between said at least two chambers.

51. Mobile unit according to claim 49, wherein said flexible pad comprises at least one incision, said at least one incision comprising incision barrier parts.

52. Mobile unit according to claim 51, wherein at least part of said incision barrier parts are designed as a covering extending at least in part in a vertical direction.

53. Mobile unit according to claim 51, wherein said at least one incision and said incision barrier parts are configured to correspond essentially to support means for said object comprising landing wheels for an aircraft or wheels for a vehicle, a trailer, and/or in such a manner that said incision barrier parts can be placed covering said support means.

54. Mobile unit according to claim 51, wherein said at least one incision comprises connecting means for connecting the two edges of the incision for at least part of the incision.

55. Mobile unit according to claim 54, wherein said connecting means for connecting the two edges of the incision are designed to be essentially fluid-tight.

56. Mobile unit according to claim 54, wherein said connecting means for connecting the two edges of the incision comprise Velcro parts, zip-fastener parts or similar means.

57. Mobile unit according to claim 49, wherein said collecting pad for collecting of a fluid comprises at least two of said flexible pads, each comprising barrier parts, wherein said flexible pads are designed for being assembled in a modular manner.

58. Mobile unit according to claim 39, wherein said collecting pad comprises
a flexible base pad and
barrier parts extending essentially along a periphery of said flexible pad, said barrier parts being at least in part accommodated for folding and comprising inflatable parts, and
wherein said flexible base pad comprises at least two parts connected to each other to form said base part by means of complementary connecting means that are substantially fluid-tight and may be disconnected from each other.

59. Mobile unit according to claim 58, wherein said connecting means for connecting two edges of said at least two parts comprise Velcro parts, zip-fastener parts or similar means.

60. Mobile unit according to claim 39, wherein, said collecting pad comprises
a flexible base pad and
barrier parts extending essentially along a periphery of said flexible pad, said barrier parts being at least in part accommodated for folding and comprising inflatable parts, and
wherein said flexible pad comprises at least one incision, said at least one incision comprising incision barrier parts.

61. Mobile unit according to claim 60, wherein at least part of said incision barrier parts are designed as a covering extending at least in part in a vertical direction.

62. Mobile unit according to claim 60, wherein said at least one incision and said incision barrier parts are configured to correspond essentially to support means for said object comprising landing wheels for an aircraft or wheels for a vehicle, a trailer, and/or a machine, in such a manner that said incision barrier parts can be placed covering said support means.

63. Mobile unit according to claim 60, wherein said at least one incision comprises connecting means for connecting two edges of the incision for at least part of the incision.

64. Mobile unit according to claim 63, wherein said connecting means for connecting the two edges of the incision are designed to be essentially fluid-tight.

65. Mobile unit according to claim 63, wherein said connecting means for connecting the two edges of the incision comprise Velcro parts, zip-fastener parts or similar means.

66. Mobile unit according to claim 49, wherein said collecting pad comprises inlet means comprising a tube for transferring collected fluid away from the collecting pad.

67. Mobile unit according to claim 66, wherein said inlet means comprises a connection pipe extending through the collecting pad.

68. Mobile unit according to claim 66, wherein said inlet means comprises a conduit placed at one or both ends of the collecting pad extending essentially along the barrier parts inside the collecting pad, said conduit comprising inlet holes facing downwards and a connecting part for fluid transferring means.

69. Mobile unit according to claim 49, wherein said flexible base pad and/or said barrier parts are manufactured from a material that is fluid-tight and resistant to cleaning agents, oil, fuel etc.

70. Mobile unit according to claim 49, wherein said flexible base pad and/or said barrier parts are manufactured from a material with a surface having efficient friction properties also when the surface is wet.

71. Mobile unit according to claim 49, wherein said flexible base pad is manufactured from a reinforced material comprising web-reinforcing means.

72. Mobile unit according to claim 49, wherein said flexible base pad is provided with at least a further reinforcing layer in specific areas comprising tracks for wheels of vehicles.

73. Mobile unit according to claim 49, wherein said barrier parts are connected to said flexible base pad by means of welding or gluing.

74. Mobile unit according to claim 49, wherein said collecting pad further comprises cover means for covering an object on the pad, said cover having at least one opening through which said object can pass, and closing means for said opening.

75. Method of treating of objects such as vehicles, said method comprising:
supplying a collecting pad with barrier means, said collecting pad being stored on a separate handling device, which is transported on a mobile unit,
unloading said handling device,
positioning said handling device,
unrolling said collecting pad from said handling device and moving said handling unit correspondingly,
deploying said barrier means,
arranging tube connections for transporting collected fluids, from said collecting pad to a storage tank, and
arranging means for supplying and delivering water for washing and cleaning said object.
